(19) United States
(12) Patent Application Publication
(10) Pub. No.: US 2025/0249362 A1
(43) Pub. Date: Aug. 7, 2025

(54) Method and Apparatus for Displaying Virtual Object, Terminal, and Storage Medium

(71) Applicant: Tencent Technology (Shenzhen) Company Limited, Shenzhen (CN)

(72) Inventor: Xiaoquan Huang, Guangdong (CN)

(21) Appl. No.: 19/187,209

(22) Filed: Apr. 23, 2025

Related U.S. Application Data
(63) Continuation of application No. PCT/CN2024/080118, filed on Mar. 5, 2024.

(30) Foreign Application Priority Data
Apr. 27, 2023 (CN) 2023104808276

(51) Int. Cl. A63F 13/52

(52) U.S. Cl. CPC A63F 13/52

(57) ABSTRACT

A method and an apparatus for displaying a virtual object, a terminal, and a storage medium in the field of human-computer interaction technologies are disclosed. The method includes: displaying a virtual battle image, the virtual battle image corresponding to a battle perspective of a first virtual object; displaying, in the virtual battle image when a second virtual object exists in the battle perspective, the second virtual object in a camp hidden state, the second virtual object not eliminating another virtual object in the virtual battle; and displaying, in the virtual battle image when another virtual object is eliminated by the second virtual object and the second virtual object exists in the battle perspective, the second virtual object in a camp disclosed state. Battle forms in which camps are used as a battle mode to perform a virtual battle are enriched.

### CROSS REFERENCE TO RELATED APPLICATIONS

This application is a continuation application of PCT Patent Application No. PCT/CN2024/080118, filed on Mar. 5, 2024, which claims priority to Chinese Patent Application No. 202310480827.6, filed on Apr. 27, 2023, each entitled “METHOD AND APPARATUS FOR DISPLAYING VIRTUAL OBJECT, TERMINAL, AND STORAGE MEDIUM,” and each of which is incorporated herein by reference in its entirety.

### FIELD

Embodiments of the present disclosure relate to the field of human-computer interaction technologies, and in particular, to a method and an apparatus for displaying a virtual object, a terminal, and a storage medium.

### BACKGROUND

Currently, games in which teams are built in a form of camps to complete a battle are increasingly popular.

A virtual object completes team building before entering a virtual battle. After each virtual object entering the virtual battle, camp information corresponding to the virtual object is directly displayed, so that a player may distinguish, based on the camp information displayed on an interface, a virtual object of an enemy camp from a virtual object of a camp of the player, and attack the virtual object of the enemy camp until all virtual objects of the enemy camp are eliminated, so as to achieve a victory of the battle.

When a virtual object enters a battle, camp information of each virtual object is directly displayed on a battle interface, reducing fun and intensity in a battle process.

### SUMMARY

Embodiments of the present disclosure provide a method and an apparatus for displaying a virtual object, a terminal, and a storage medium. Technical solutions are as follows:

In an aspect, an embodiment of the present disclosure provides a method for displaying a virtual object, the method being performed by a terminal, and including:
displaying a virtual battle image, the virtual battle image corresponding to a battle perspective of a first virtual object;
displaying, in the virtual battle image when a second virtual object exists in the battle perspective, the second virtual object in a camp hidden state, the second virtual object not eliminating another virtual object in a virtual battle, and the camp hidden state referring to a state in which a camp to which a virtual object belongs is hidden in the virtual battle; and
displaying, in the virtual battle image when another virtual object is eliminated by the second virtual object and the second virtual object exists in the battle perspective, the second virtual object in a camp disclosed state, the camp disclosed state referring to a state in which a camp to which a virtual object belongs is disclosed in the virtual battle.

In another aspect, an embodiment of the present disclosure provides an apparatus for displaying a virtual object, the apparatus including:
a first display module, configured to display a virtual battle image, the virtual battle image corresponding to a battle perspective of a first virtual object;
a second display module, configured to display, in the virtual battle image when a second virtual object exists in the battle perspective, the second virtual object in a camp hidden state, the second virtual object not eliminating another virtual object in a virtual battle, and the camp hidden state referring to a state in which a camp to which a virtual object belongs is hidden in the virtual battle; and
a third display module, configured to display, in the virtual battle image when another virtual object is eliminated by the second virtual object and the second virtual object exists in the battle perspective, the second virtual object in a camp disclosed state, the camp disclosed state referring to a state in which a camp to which a virtual object belongs is disclosed in the virtual battle.

In another aspect, an embodiment of the present disclosure provides a terminal, including a processor and a memory, the memory having at least one program stored therein, and the at least one program being loaded and executed by the processor to implement the method for displaying a virtual object according to the foregoing aspect.

In another aspect, an embodiment of the present disclosure provides a non-transitory computer-readable storage medium, the computer-readable storage medium having at least one program stored therein, and the at least one program being loaded and executed by a processor to implement the method for displaying a virtual object according to the foregoing aspect.

In another aspect, an embodiment of the present disclosure provides a computer program product, including computer instructions, and the computer instructions being stored in a computer-readable storage medium. A processor of a computer device reads the computer instructions from the computer-readable storage medium, the processor executing the computer instructions, to enable the computer device to perform the method for displaying a virtual object according to the foregoing aspect.

In the embodiments of the present disclosure, at a start stage of a battle, a camp to which each virtual object belongs is hidden from another virtual object. When a virtual object does not eliminate another virtual object in a virtual battle, a camp to which the virtual object belongs remains in a hidden state. When the virtual object eliminates another virtual object in the virtual battle, the camp to which the virtual object belongs is switched to a disclosed state. A trigger condition for disclosing a camp to which a virtual object belongs is set, so that a player can be promoted to control a virtual object to actively eliminate another virtual object, to disclose a camp to which the virtual object belongs. Therefore, a battle tempo can be accelerated, battle duration can be shortened, and a processing pressure of a server can be reduced.

In addition, an attack is launched when a camp to which another party belongs is unknown, so that randomness of a virtual battle can be improved, impact of strength of both parties in the battle on a battle result is reduced, and stimulation and fun of the virtual battle are improved.

### BRIEF DESCRIPTION OF THE DRAWINGS

FIG. 1 is a schematic diagram of an implementation environment according to an embodiment of the present disclosure.

FIG. 2 is a flowchart of a method for displaying a virtual object according to an exemplary embodiment of the present disclosure.

FIG. 3 is a schematic diagram of an interface displaying a second virtual object according to an exemplary embodiment of the present disclosure.

FIG. 4 is a flowchart of a method for displaying a virtual object according to another exemplary embodiment of the present disclosure.

FIG. 5 is a schematic diagram of an interface on which a first virtual object is controlled to enter a virtual battle according to an exemplary embodiment of the present disclosure.

FIG. 6 is a schematic diagram of an interface displaying object identifiers in different states according to an exemplary embodiment of the present disclosure.

FIG. 7 is a schematic diagram of an interface on which a first virtual object is equipped with a virtual item according to an exemplary embodiment of the present disclosure.

FIG. 8 is a schematic diagram of an interface displaying different quantities of item controls according to an exemplary embodiment of the present disclosure.

FIG. 9 is a schematic diagram of an interface displaying a camp chat control in different states according to an exemplary embodiment of the present disclosure.

FIG. 10 is a flowchart of a method for displaying a virtual object according to another exemplary embodiment of the present disclosure.

FIG. 11 is a schematic diagram of an interface displaying a virtual battle result according to another exemplary embodiment of the present disclosure.

FIG. 12 is a diagram of a time sequence of interaction between a terminal and a server according to an exemplary embodiment of the present disclosure.

FIG. 13 is a block diagram of a structure of an apparatus for displaying a virtual object according to an exemplary embodiment of the present disclosure.

FIG. 14 is a block diagram of a structure of a terminal according to an exemplary embodiment of the present disclosure.

### DETAILED DESCRIPTION

Implementations of the present disclosure are further described below in detail with reference to the accompanying drawings.

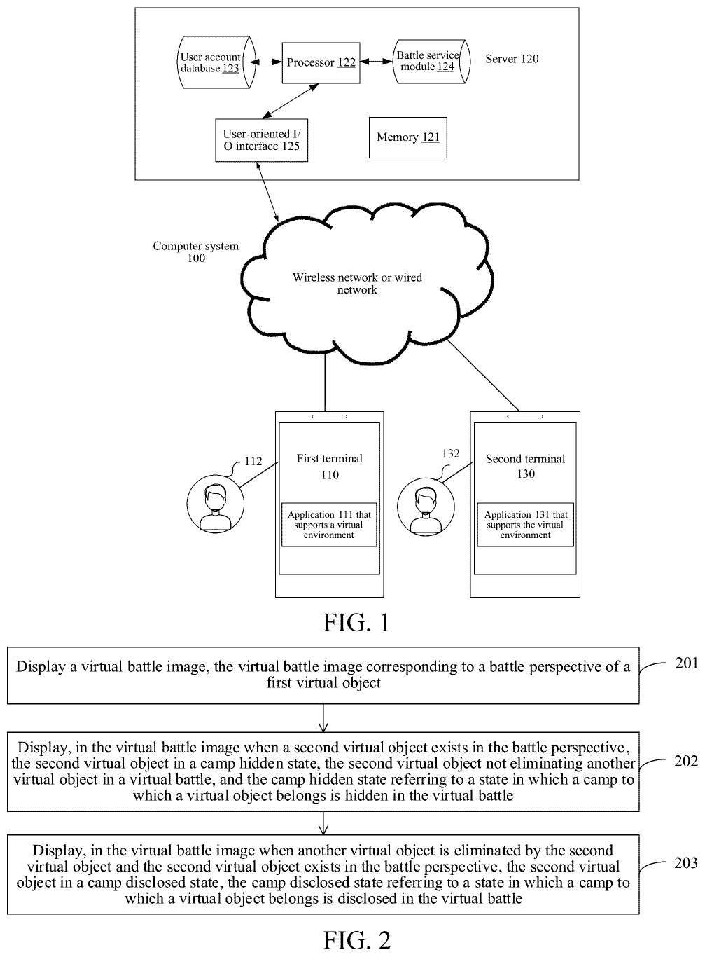

FIG. 1 is a schematic diagram of an implementation environment according to an embodiment of the present disclosure. The implementation environment may include: a first terminal 110, a server 120, and a second terminal 130.

An application program 111 that supports a virtual environment is run in the first terminal 110, and the application program 111 may be a multiplayer online battle program. When the first terminal runs the application program 111, a user interface of the application program 111 is displayed on a screen of the first terminal 110. The application program 111 may be either of a multiplayer online battle arena (MOBA) game and a simulation game (SLG). In this embodiment, an example in which the application program 111 is a first-person shooter (FPS) game is used for description. The first terminal 110 is a terminal used by a first user 112. The first user 112 uses the first terminal 110 to control a first virtual object in a virtual environment to perform activities. The first virtual object may be referred to as a main control virtual object of the first user 112. The activities of the first virtual object include but are not limited to: at least one of adjusting a body posture, crawling, walking, running, riding, flying, jumping, driving, picking, shooting, attacking, throwing, and releasing a skill. For example, the first virtual object is a first virtual character such as a simulated character or an anime character.

An application program 131 that supports a virtual environment is run in the second terminal 130, and the application program 131 may be the multiplayer online battle program. When the second terminal 130 runs the application 131, a user interface of the application 131 is displayed on a screen of the second terminal 130. A client may be either of a MOBA game and an SLG game. In this embodiment, an example in which the application program 131 is an FPS game is used for description. The second terminal 130 is a terminal used by a second user 132. The second user 132 uses the second terminal 130 to control a second virtual object in a virtual environment to perform activities, and the second virtual object may be referred to as a main control virtual character of the second user 132. For example, the second virtual object is a second virtual character, such as the simulated character or the anime character.

In one embodiment, the first virtual object and the second virtual object are in the same virtual world. In one embodiment, the first virtual object and the second virtual object may belong to the same camp, the same team, and the same organization, and have a friend relationship or have a temporary communication permission. In one embodiment, the first virtual object and the second virtual object may belong to different camps, different teams, and different organizations, or have an adversarial relationship.

In one embodiment, application programs installed in the first terminal 110 and the second terminal 130 may be the same, or application programs installed in the two terminals are application programs of the same type on different operating system platforms (that is, Android or iOS). The first terminal 110 may generally refer to one of a plurality of terminals, and the second terminal 130 may generally refer to the other of the plurality of terminals. In this embodiment, only the first terminal 110 and the second terminal 130 are used as examples. Device types of the first terminal 110 and the second terminal 130 are the same or different. The device type includes: at least one of a smartphone, a tablet computer, an e-book reader, a moving picture experts group audio layer III (MP3) player, a moving picture experts group audio layer IV (MP4) player, a laptop portable computer, and a desktop computer.

FIG. 1 shows only two terminals. However, a plurality of other terminals can access the server 120 in different embodiments. In one embodiment, one or more terminals are terminals corresponding to a developer. By installing, in the terminal, a developing and editing platform for an application program that supports a virtual environment, the developer can edit and update the application program in the terminal, and transmit an updated application program installation package to the server 120 through a wired or wireless network. The first terminal 110 and the second terminal 130 may download the application program installation package from the server 120 to update the application program.

The first terminal 110, the second terminal 130, and another terminal are connected to the server 120 through a wired network or wireless network.

The server 120 includes at least one of a server, a server cluster including a plurality of servers, a cloud computing platform, and a virtualization center. The server 120 is configured to provide a backend service for an application program that supports a three-dimensional virtual environment. In one embodiment, the server 120 undertakes primary computing work, and a terminal undertakes secondary computing work. Alternatively, the server 120 undertakes the secondary computing work, and the terminal undertakes the primary computing work. Alternatively, a distributed computing architecture is used between the server 120 and the terminal to perform collaborative computing.

For example, the server 120 includes a memory 121, a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal, for example, avatars, nicknames, combat capacity indexes, and service zones of the user accounts. The battle service module 124 is configured to provide a plurality of battle rooms for users to have a battle, for example, a 1V1 battle, a 3V3 battle, or a 5V5 battle. The user-oriented I/O interface 125 is configured to establish communication and exchange data with the first terminal 110 and/or the second terminal 130 through a wireless network or wired network.

In this embodiment of the present disclosure, in addition to a conventional battle mode, the server 120 further provides a blind battle mode. Different from the conventional battle mode in which, after each virtual object enters a virtual battle, a camp to which each virtual object belongs is visible to another virtual object, in the blind battle mode, the camp to which each virtual object belongs is initially in a hidden state, to be specific, virtual objects do not know camps to which other virtual objects belong. To disclose a camp to which a player belongs, the player needs to control a virtual object to eliminate another virtual object. In other words, the server 120 further needs to maintain a hidden/disclosed state of a camp to which each virtual object in a virtual battle belongs.

FIG. 2 is a flowchart of a method for displaying a virtual object according to an exemplary embodiment of the present disclosure. In this embodiment, an example in which the method is applied to the first terminal 110 or the second terminal 130 in the implementation environment shown in FIG. 1 or another terminal in the implementation environment is used for description. The method includes the following operations.

Operation 201: Display a virtual battle image, the virtual battle image corresponding to a battle perspective of a first virtual object.

A virtual object refers to a main control object of a user in a three-dimensional virtual environment. For example, the virtual object may be at least one of a virtual character, a virtual animal, an anime character, and a virtual vehicle.

The virtual battle image is an image presented to a player after the virtual object performs a virtual battle. The virtual battle image may include another virtual object that is in the same virtual environment with a virtual object mainly controlled by a terminal.

The virtual environment refers to a three-dimensional environment in which the virtual object locates in a virtual world during running of an application program in the terminal. In one embodiment, in this embodiment of the present disclosure, the virtual environment is observed by using a camera model.

In one embodiment, the camera model automatically follows a virtual character in the virtual world. To be specific, when a location of a virtual object in the virtual world changes, a location of the camera model changes simultaneously along with the location of the virtual object in the virtual world, and the camera model is always within a preset distance range of the virtual object in the virtual world. In one embodiment, in an automatic following process, relative locations between the camera model and the virtual object remain unchanged.

The camera model refers to a three-dimensional model located around the virtual object in the virtual world. When a first-person perspective is used, the camera model is located near or at a head of the virtual object. When a third-person perspective is used, the camera model may be located behind the virtual object and bound to the virtual object, or may be located at any location at a preset distance to the virtual object. The virtual object in the virtual world may be observed from different perspectives by using the camera model. In one embodiment, when the third-person perspective is a first-person over-the-shoulder perspective, the camera model is located behind the virtual object (such as the head and a shoulder of the virtual object). In one embodiment, in addition to the first-person perspective and the third-person perspective, another perspective, such as a top-view perspective, is further included. When the top-view perspective is used, the camera model may be located above the head of the virtual object, and the top-view perspective is a perspective for observing the virtual world from the air. In one embodiment, the camera model is not actually displayed in the virtual world. In other words, the camera model is not displayed in the virtual world that is displayed on a user interface.

In one embodiment, an example in which the virtual object mainly controlled by the terminal is the first virtual object is used. In a possible implementation, the terminal displays the virtual battle image. The virtual battle image is an image of a virtual environment observed after the first virtual object performs a virtual battle, and corresponds to the battle perspective of the first virtual object. In other words, the virtual battle image is an image obtained by observing a virtual battle scene from the battle perspective of the first virtual object. The virtual battle image may be a first-person virtual battle image of the first virtual object (to be specific, an image obtained by the first virtual object by observing the virtual battle scene from the first-person perspective), or a third-person virtual battle image (to be specific, an image obtained by the first virtual object by observing the virtual battle scene from the third-person perspective).

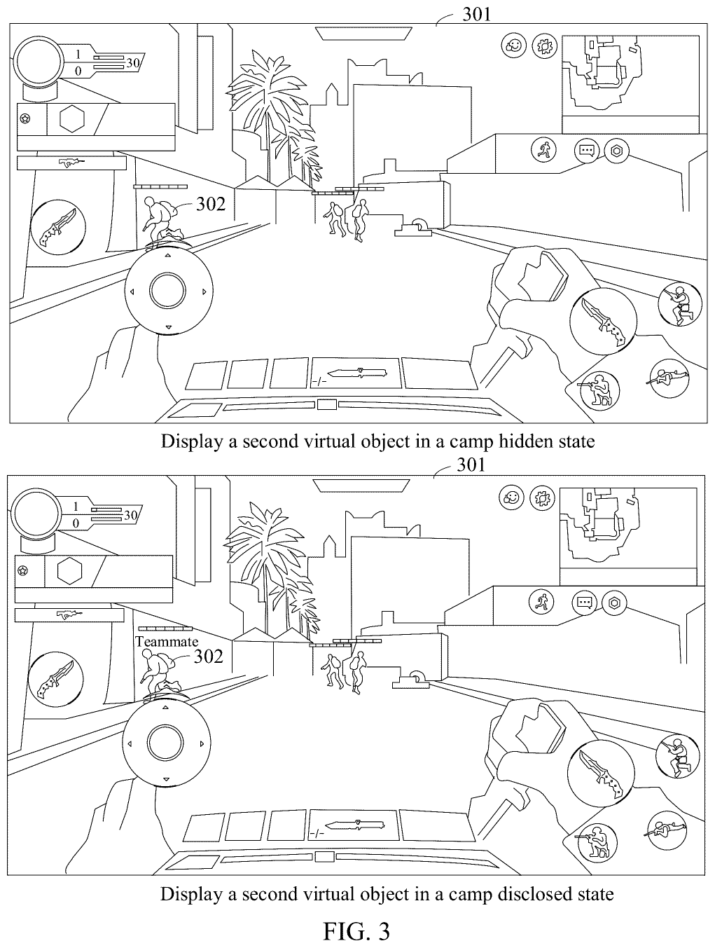

For example, as shown in FIG. 3, a terminal displays a virtual battle image 301, and the virtual battle image 301 corresponds to the battle perspective of the first virtual object.

Operation 202: Display, in the virtual battle image when a second virtual object exists in the battle perspective, the second virtual object in a camp hidden state, the second virtual object not eliminating another virtual object in the virtual battle, and the camp hidden state referring to a state in which a camp to which a virtual object belongs is hidden in the virtual battle.

In one embodiment, the virtual battle includes at least two camps, and each camp includes at least two virtual objects. For example, the virtual battle may be in a 3V3 mode, or may be in a 5V5 mode. This is not limited in this embodiment of the present disclosure.

In a possible implementation, to improve stimulation of a battle among the virtual objects in the virtual battle, when a virtual object does not eliminate another virtual object, the terminal may hide camp information of the virtual object, so that, in a virtual battle image corresponding to each virtual object, a player cannot view a camp to which the virtual object belongs. In other words, in an initial battle state, a camp to which each virtual object belongs is hidden, and when a virtual object does not eliminate another virtual object, a camp to which the virtual object belongs remains in a hidden state.

In a possible implementation, when controlling a virtual object to enter the virtual battle, the terminal may send, to a server, a request packet for entering the virtual battle, so that, when receiving the request packet, the server verifies an object attribute corresponding to the virtual object and player information, and sends a network packet for hiding camp information to terminals corresponding to all the virtual objects in the same virtual battle. In this way, the terminals hide the camp information of the virtual objects, and control the virtual objects to enter the virtual battle. Therefore, all the virtual objects in the virtual battle are in the camp hidden state.

In one embodiment, the camp hidden state refers to the state in which a camp to which a virtual object belongs is hidden in the virtual battle. To be specific, in a battle perspective of the virtual object, all players cannot view a camp to which a virtual object in the camp hidden state belongs.

In some embodiments, when a virtual object controlled by a player is in the camp hidden state, a camp to which the virtual object belongs is visible to the current player. Alternatively, when the virtual object controlled by the player is in the camp hidden state, the player cannot know the camp to which the virtual object belongs.

In a possible implementation, when the second virtual object exists in the battle perspective of the first virtual object, and the second virtual object does not eliminate another virtual object in the virtual battle, the terminal displays, in the virtual battle image, the second virtual object in the camp hidden state, so that a player cannot determine whether the first virtual object and the second virtual object belong to the same camp.

In one embodiment, when the second virtual object appears in the battle perspective of the first virtual object, the terminal obtains a display state of a camp to which the second virtual object belongs. When the display state is a hidden state, the terminal displays the second virtual object in the camp hidden state. The display state may be sent by the server to the terminal based on a situation that a virtual object eliminates another virtual object.

For example, as shown in FIG. 3, when a second virtual object 302 exists in the battle perspective of the first virtual object, and the second virtual object 302 does not eliminate another virtual object, the terminal displays, in the virtual battle image 301, the second virtual object 302 in the camp hidden state, that is, the first virtual object cannot know a camp to which the second virtual object 302 belongs.

Operation 203: Display, in the virtual battle image when another virtual object is eliminated by the second virtual object and the second virtual object exists in the battle perspective, the second virtual object in a camp disclosed state, the camp disclosed state referring to a state in which a camp to which a virtual object belongs is disclosed in the virtual battle.

In one embodiment, to help a player determine, in the virtual battle, a camp to which each virtual object belongs, so as to perform a battle in the virtual battle, the terminal may disclose a camp to which a virtual object that has eliminated another virtual object belongs.

In one embodiment, the eliminated virtual object may be another virtual object that belongs to the same camp as the virtual object, or may be another virtual object that belongs to a camp different from that of the virtual object.

In one embodiment, the eliminated virtual object may be a virtual object in the camp hidden state, or may be a virtual object in the camp hidden state.

Further, by eliminating another virtual object in the virtual battle, a controlled virtual object may enter the camp disclosed state, so that virtual objects belonging to the same camp may complete team building in the virtual battle, and perform a camp battle.

In one embodiment, the camp disclosed state is the state in which a camp to which a virtual object belongs is disclosed in the virtual battle. To be specific, when a virtual object that has eliminated another virtual object appears in a battle perspective of each virtual object, a player corresponding to each virtual object can see information about a camp to which the virtual object belongs.

In some embodiments, in a perspective of another virtual object, a virtual object has at least one of the following display differences when the virtual object is in the camp disclosed state and the camp hidden state: a difference in a model display style of the virtual object and a difference in an association-information display style of the virtual object. The model display style includes a color of a model contour, saliency degree of the model contour, and the like. The association-information display style includes a name display style of the virtual object, whether to display the information about the camp to which the virtual object belongs, a state display style (such as a color of a health bar) of the virtual object, and the like. A specific difference between the camp disclosed state and the camp hidden state is not limited in this embodiment of the present disclosure.

In a possible implementation, when a terminal controls a virtual object to attack another virtual object and eliminate the another virtual object, the terminal may send a network packet with elimination information to the server, and the server verifies the network packet. When it is confirmed that the elimination is successful, the server delivers, to the terminal, a network packet for displaying camp information, so that the terminal discloses a camp to which the virtual object belongs.

In another possible implementation, after receiving an elimination event reported by a terminal corresponding to the second virtual object, the server sends, to another terminal in the battle, an instruction of updating a display state. After receiving the instruction, each terminal updates the display state of the second virtual object from a hidden state to a disclosed state, to display the second virtual object in the camp disclosed state when the second virtual object appears in a battle perspective.

In a possible implementation, when the second virtual object exists in the battle perspective of the first virtual object, and another virtual object is eliminated by the second virtual object, the terminal displays, in the virtual battle image, the second virtual object in the camp disclosed state.

For example, as shown in FIG. 3, when the second virtual object 302 exists in the battle perspective of the first virtual object, and another virtual object is eliminated by the second virtual object 302, the terminal displays, in the virtual battle image 301, the second virtual object 302 in the camp disclosed state, that is, the first virtual object can see the camp to which the second virtual object 302 belongs.

In conclusion, in this embodiment of the present disclosure, at a start stage of the battle, a camp to which each virtual object belongs is hidden from another virtual object. When a virtual object does not eliminate another virtual object in the virtual battle, a camp to which the virtual object belongs remains in the hidden state. When the virtual object eliminates another virtual object in the virtual battle, the camp to which the virtual object belongs is switched to the disclosed state. A trigger condition for disclosing a camp to which a virtual object belongs is set, so that a player can be promoted to control a virtual object to actively eliminate another virtual object, to disclose a camp to which the virtual object belongs. Therefore, a battle tempo can be accelerated, battle duration can be shortened, and a processing pressure of a server can be reduced.

In addition, an attack is launched when a camp to which another party belongs is unknown, so that randomness of a virtual battle can be improved, impact of strength of both parties in the battle on a battle result is reduced, and stimulation and fun of the virtual battle are improved.

In a possible implementation, to improve efficiency of determining a camp to which another virtual object belongs by a virtual object, to enable each virtual object in the virtual battle to be capable of determining another virtual object in the same camp as soon as possible, different object identifiers may be set for virtual objects that are in the camp hidden state and the camp disclosed state.

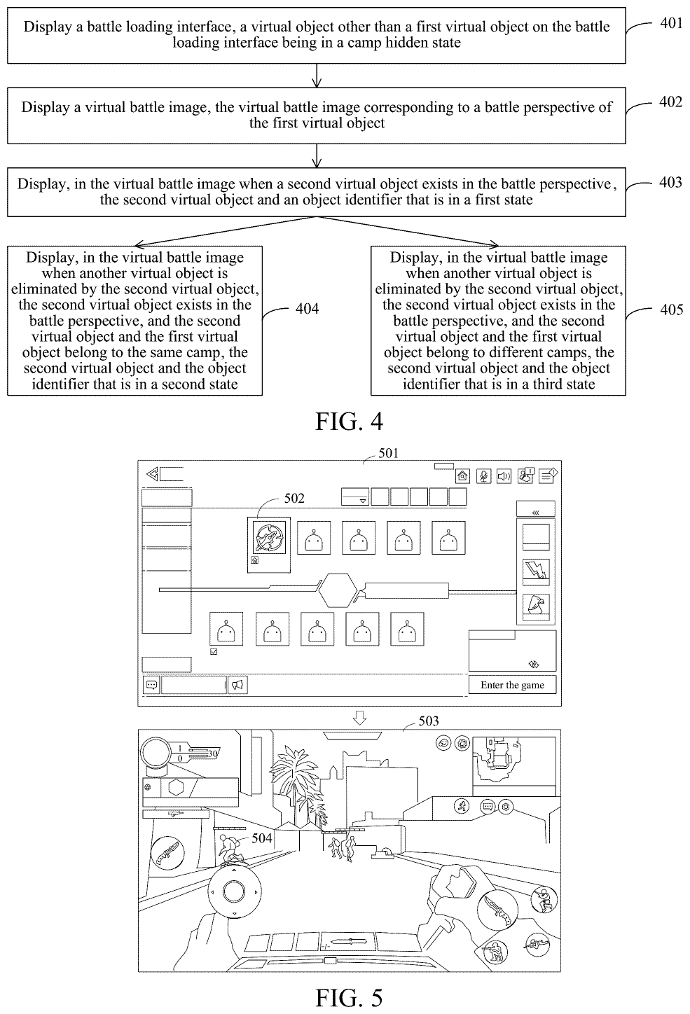

FIG. 4 is a flowchart of a method for displaying a virtual object according to an exemplary embodiment of the present disclosure. The method includes the following operations.

Operation 401: Display a battle loading interface, a virtual object other than a first virtual object on the battle loading interface being in a camp hidden state.

In one embodiment, before a virtual object enters a battle, to prevent a player from determining, based on player information, such as a player account, an account level, and an account avatar, corresponding to the virtual object, a camp to which the virtual object belongs, when receiving a trigger operation of the player on a camp matching control or a camp opening control, a terminal displays the battle loading interface, and all virtual objects on the battle loading interface that are other than a virtual object controlled by the player are in the camp hidden state.

In one embodiment, on the battle loading interface, the terminal displays player information, such as a player account, an account level, and an account avatar, corresponding to the first virtual object, and player information corresponding to another virtual object is displayed in an anonymous manner. For example, the player information corresponding to the another virtual object is displayed in a machine state.

For example, as shown in FIG. 5, the terminal displays a battle loading interface 501, the battle loading interface 501 displays player information 502 corresponding to the first virtual object, and player information corresponding to other virtual objects are all in the camp hidden state.

Operation 402: Display a virtual battle image, the virtual battle image corresponding to a battle perspective of the first virtual object.

For an implementation of operation 402, refer to operation 201, and details are not described herein again.

Operation 403: Display, in the virtual battle image when a second virtual object exists in the battle perspective, the second virtual object and an object identifier in a first state.

In a possible implementation, when the second virtual object exists in the battle perspective of the first virtual object, and the second virtual object does not eliminate another virtual object, the terminal displays the second virtual object in the virtual battle image, and displays the object identifier that is in the first state and that corresponds to the second virtual object.

In one embodiment, object identifiers corresponding to virtual objects in a virtual battle are different. The object identifier may be an account name corresponding to a virtual object, or may be another object identifier (such as an avatar) that can be easily distinguished by a player. This is not limited in this embodiment of the present disclosure.

In one embodiment, to facilitate distinguishing between object identifiers corresponding to different virtual objects, the terminal may display an object identifier around a virtual object, for example, at a location above a head of the virtual object.

In one embodiment, to hide a camp to which a virtual object that does not eliminate another virtual object belongs, the first state may be an identifier hidden state. For example, when the object identifier is the account name, the terminal may set the account name to an invisible state.

In one embodiment, the object identifier in the first state has a function of distinguishing between different virtual objects but does not have a function of distinguishing between camps to which the virtual objects belong. For example, in a conventional mode, when the second virtual object in the field of view belongs to the same camp as a virtual object of a player, an account name of the second virtual object is highlighted in green. When the second virtual object in the field of view belongs to a camp different from that of the virtual object of the player, the account name of the second virtual object is highlighted in red. However, in this embodiment of the present disclosure, when the second virtual object does not eliminate another virtual object, the account name of the second virtual object is not highlighted, or is highlighted in a color other than red or green, for example, is highlighted in white.

In a possible implementation, to help a player quickly find virtual objects in different virtual environment locations in the virtual battle, the terminal may display a virtual map on a virtual battle interface corresponding to the virtual battle image, so as to display, based on location information of a virtual object in a virtual environment, coordinates of a point corresponding to the virtual object in the virtual map.

In one embodiment, when the second virtual object does not eliminate another virtual object, the terminal may hide, in the virtual map, coordinates of a point of the second virtual object in the virtual environment, and only display coordinates of a point of the first virtual object in the virtual environment.

In another possible manner, when the second virtual object does not eliminate another virtual object, the terminal may hide, in the virtual map, the coordinates of the point of the second virtual object in the virtual environment, but a display manner of the coordinates of the point is different from that of coordinates of a point of another virtual object that completes elimination. For example, for a virtual object that does not eliminate another virtual object, coordinates of a point of the virtual object are white coordinates. For a virtual object that eliminates another virtual object, a color of coordinates of a point of the virtual object is related to a camp to which the virtual object belongs, and is not white.

For example, as shown in FIG. 5, when a second virtual object 504 exists in the battle perspective of the first virtual object, and the second virtual object 504 does not eliminate another virtual object, the terminal displays the second virtual object 504 in a virtual battle image 503, and an object identifier of the second virtual object 504 is in the invisible state.

Operation 404: Display, in the virtual battle image, when another virtual object is eliminated by the second virtual object, the second virtual object exists in the battle perspective, and the second virtual object and the first virtual object belong to the same camp, the second virtual object and an object identifier that is in a second state.

In one embodiment, when another virtual object is eliminated by the second virtual object, the second virtual object enters the camp disclosed state. Therefore, to help the player determine whether the second virtual object belongs to the same camp as the virtual object controlled by the player, the terminal may display object identifiers in different states in virtual battle images corresponding to different virtual objects.

In one embodiment, when the first virtual object and the second virtual object belong to the same camp, the terminal may display, around the second virtual object in the virtual battle image corresponding to the first virtual object, the object identifier that is in the second state. When the first virtual object and the second virtual object belong to different camps, the terminal may display, around the second virtual object in the virtual battle image corresponding to the first virtual object, an object identifier that is in a third state. The second state is different from the third state, and the second state and the third state are also different from the first state.

In one embodiment, state attributes of the second state and the third state may be colors. In other words, the object identifier in the second state and the object identifier in the third state correspond to different display colors. In one embodiment, state attributes of the second state and the third state may alternatively be fonts. In other words, the object identifier in the second state and the object identifier in the third state correspond to different fonts. In one embodiment, the object identifier in the second state and the object identifier in the third state have different highlight effects, such as highlighted display effects of different colors and bold display effects of different colors. The state attributes of the second state and the third state are not specifically limited in this embodiment of the present disclosure.

For example, when the first virtual object and the second virtual object belong to the same camp, the terminal may display a blue object identifier around the second virtual object in the virtual battle image. When the first virtual object and the second virtual object belong to different camps, the terminal may display a red object identifier around the second virtual object in the virtual battle image.

In a possible implementation, when another virtual object is eliminated by the second virtual object and the second virtual object exists in the battle perspective corresponding to the first virtual object, and the second virtual object and the first virtual object belong to the same camp, the terminal may display, in the virtual battle image, the second virtual object and the object identifier that is in the second state and that corresponds to the second virtual object.

In a possible implementation, after a main control terminal corresponding to the second virtual object controls the second virtual object to eliminate another virtual object, the main control terminal sends a network packet with elimination information to a server. The server verifies the network packet. When it is confirmed that the elimination is successful, the server delivers, to terminals in the virtual battle, a network packet for displaying camp information. The network packet may include a display state of an object identifier. In one embodiment, the server may send the object identifier in the second state to a main control terminal corresponding to a virtual object that belongs to the same camp as the second virtual object, and send the object identifier in the third state to a main control terminal corresponding to a virtual object that belongs to a camp different from that of the second virtual object. In this way, each terminal displays, around the second virtual object in the virtual battle image based on a corresponding display state, an object identifier in a corresponding state.

In a possible implementation, when the second virtual object is in the camp disclosed state, to enable the first virtual object to find the second virtual object in the virtual environment as soon as possible, the terminal may further display, in the virtual map of the virtual battle interface, coordinates of a point corresponding to the second virtual object.

In another possible implementation, when the second virtual object is in the camp disclosed state, the terminal may adjust, based on the camp to which the second virtual object belongs, the display state, such as a display form or a display color, of the coordinates of the point corresponding to the second virtual object in the virtual map.

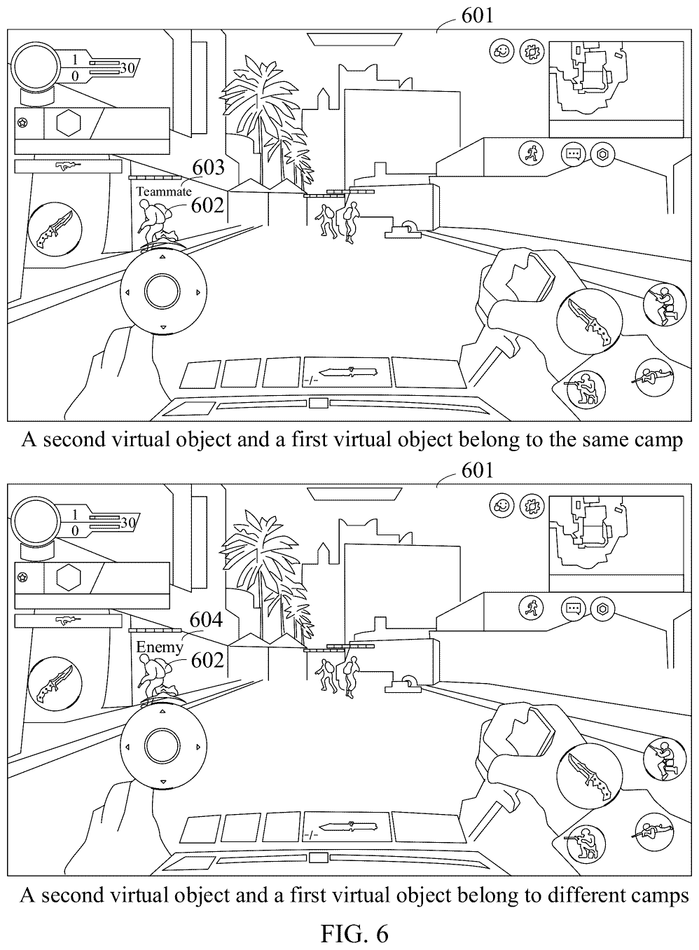

For example, as shown in FIG. 6, when a second virtual object 602 exists in the battle perspective of the first virtual object, and another virtual object is eliminated by the second virtual object 602, and the second virtual object 602 and the first virtual object belong to the same camp, the terminal displays the second virtual object 602 in a virtual battle image 601, and displays an object identifier 603 in the second state above a head of the second virtual object 602.

In one embodiment, the virtual battle interface corresponding to the virtual battle image includes a camp list, and the camp list is configured for presenting an object identifier of a virtual object in the camp disclosed state. In a possible implementation, when the second virtual object is in the camp disclosed state, the terminal may display, based on a target camp to which the second virtual object belongs, the object identifier of the second virtual object in a camp list corresponding to the target camp.

Operation 405: Display, in the virtual battle image when another virtual object is eliminated by the second virtual object, the second virtual object exists in the battle perspective, and the second virtual object and the first virtual object belong to different camps, the second virtual object and an object identifier that is in a third state.

In one embodiment, when another virtual object is eliminated by the second virtual object, the second virtual object enters the camp disclosed state. Therefore, when the second virtual object exists in the battle perspective of the first virtual object, and the first virtual object and the second virtual object belong to different camps, the terminal may display the object identifier in the third state around the second virtual object in the virtual battle image.

For example, as shown in FIG. 6, when the second virtual object 602 exists in the battle perspective of the first virtual object, and another virtual object is eliminated by the second virtual object 602, and the second virtual object 602 and the first virtual object belong to different camps, the terminal displays the second virtual object 602 in the virtual battle image 601, and displays an object identifier 604 in the third state above the head of the second virtual object 602.

In the foregoing embodiment, object identifiers that are in different states and that correspond to the second virtual object are displayed in the virtual battle image, to help the first virtual object quickly determine a current camp state of the second virtual object, and determine whether the second virtual object belongs to the same camp as the first virtual object. In this way, efficiency of determining, by a virtual object, a camp to which another virtual object belongs is improved, and battle experience of the virtual battle is optimized.

In a possible implementation, after the virtual battle starts, each virtual object in the virtual battle is in the camp hidden state, and only when a virtual object is controlled to eliminate another virtual object, the virtual object can be switched to a camp disclosed state. Consequently, when a player is uncertain about camp information of an enemy and the player, the player cannot quickly control the virtual object to perform a kill operation. In this case, to accelerate a battle process of the virtual battle, the terminal may narrow an item use permission of a virtual object in the camp hidden state by setting the item use permission, and expand an item use permission of a virtual object that actively eliminates another virtual object and exposes camp information of the virtual object.

In one embodiment, the terminal may set different states for an item control on the virtual battle interface, to set the item use permission of the virtual object.

In a possible implementation, before the virtual battle starts (for example, at a battle preparation stage), the terminal displays a battle preparation interface. A backpack item corresponding to the first virtual object is displayed on the battle preparation interface. When receiving a trigger operation of a player on the backpack item on the battle preparation interface, the terminal controls the first virtual object to be equipped with the backpack item.

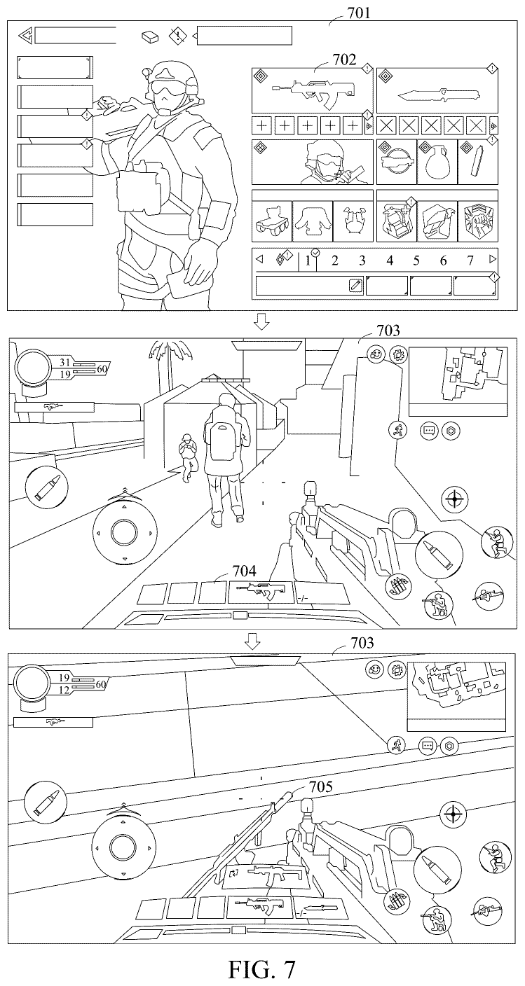

For example, as shown in FIG. 7, the terminal displays a battle preparation interface 701. Virtual items owned by the first virtual object are displayed on the battle preparation interface 701. When receiving a trigger operation of a player on a virtual item 702 on the battle preparation interface 701, the terminal controls the first virtual object to be equipped with the virtual item 702.

Further, in response to a trigger operation on a battle start control, the terminal controls the virtual object to enter the virtual battle. When the first virtual object does not eliminate another virtual object, the terminal displays, on the virtual battle interface, the item control that is in a fourth state.

In one embodiment, the fourth state of the item control may represent that the first virtual object cannot be controlled to use a virtual item, and the first virtual object cannot be controlled to release a corresponding skill. The player can obtain a usable virtual item only in a manner of controlling the first virtual object to pick up the virtual item in a virtual environment.

In one embodiment, the fourth state of the item control may alternatively represent that only a permission to use a virtual item with a low-level attribute is provided. For example, in the fourth state, the first virtual object cannot be controlled to use a virtual item with a high attack value, and only a virtual item with a low attack value, such as a virtual knife, can be used. Alternatively, the first virtual object is controlled to pick up a virtual item in a virtual environment, to obtain the usable virtual item.

In one embodiment, the fourth state of the item control may alternatively represent that the first virtual object cannot be controlled to use a virtual item exceeding a quantity threshold, or a skill exceeding an attack threshold cannot be released.

In one embodiment, the fourth state of the item control may alternatively represent that the first virtual object cannot be controlled to use a virtual item at a high frequency, or a skill cannot be released at a high frequency. That is, when the first virtual object is in the camp hidden state, there is an upper limit to a frequency of using a virtual item or releasing a skill.

For example, as shown in FIG. 7, after the first virtual object enters a virtual battle, when the first virtual object does not eliminate another virtual object, the terminal displays, on a virtual battle interface 703, an item control 704 that is in the fourth state, that is, the first virtual object cannot use an equipped virtual item. Further, the terminal controls the first virtual object to pick up a first virtual item 705 in the virtual environment, and controls the first virtual object to be equipped with and use the first virtual item 705.

In a possible implementation, when receiving an attack instruction for a third virtual object, the terminal controls the first virtual object to attack the third virtual object, so that, when the third virtual object is eliminated by the first virtual object, the terminal displays, on the virtual battle interface, the item control that is in a fifth state.

In one embodiment, the fifth state is different from the fourth state, and the fifth state of the item control represents that the first virtual object can be controlled to normally use a virtual item in the virtual battle, and the first virtual object can be normally controlled to release a corresponding skill.

In one embodiment, the third virtual object may be in the camp disclosed state, or may be in the camp hidden state.

In a possible implementation, to improve stimulation of the virtual battle, the terminal may further set, based on whether camps to which the first virtual object and the third virtual object belong are the same, item use permissions in different levels for the first virtual object that has eliminated the third virtual object. To be specific, when the third virtual object is eliminated by the first virtual object, the terminal may display, on the virtual battle interface based on camps to which the third virtual object and the first virtual object belong, the item control that is in the fifth state.

In one embodiment, when the first virtual object and the third virtual object belong to the same camp, the item use permission obtained by the first virtual object is low. When the first virtual object and the third virtual object belong to different camps, the first virtual object obtains a high item use permission. The item use permission may be a permission for a quantity of items to be used, a use frequency of an item, an attack value of an item, or the like. This is not limited in this embodiment of the present disclosure.

In a possible implementation, when the first virtual object does not eliminate another virtual object, the terminal displays, on the virtual battle interface, the item control that is in the fourth state. The fourth state is an untriggerable state. When the third virtual object is eliminated by the first virtual object, the terminal displays, on the virtual battle interface, the item control that is in the fifth state. The fifth state is a triggerable state.

In one embodiment, when at least two item controls (that is, at least two virtual items are configured before a battle) exist, the terminal determines the camps to which the first virtual object and the third virtual object belong. When the first virtual object and the third virtual object belong to the same camp, the terminal displays, on the virtual battle interface, a first quantity of item controls that are in the triggerable state. When the first virtual object and the third virtual object belong to different camps, the terminal displays, on the virtual battle interface, a second quantity of item controls that are in the triggerable state. The second quantity is greater than the first quantity.

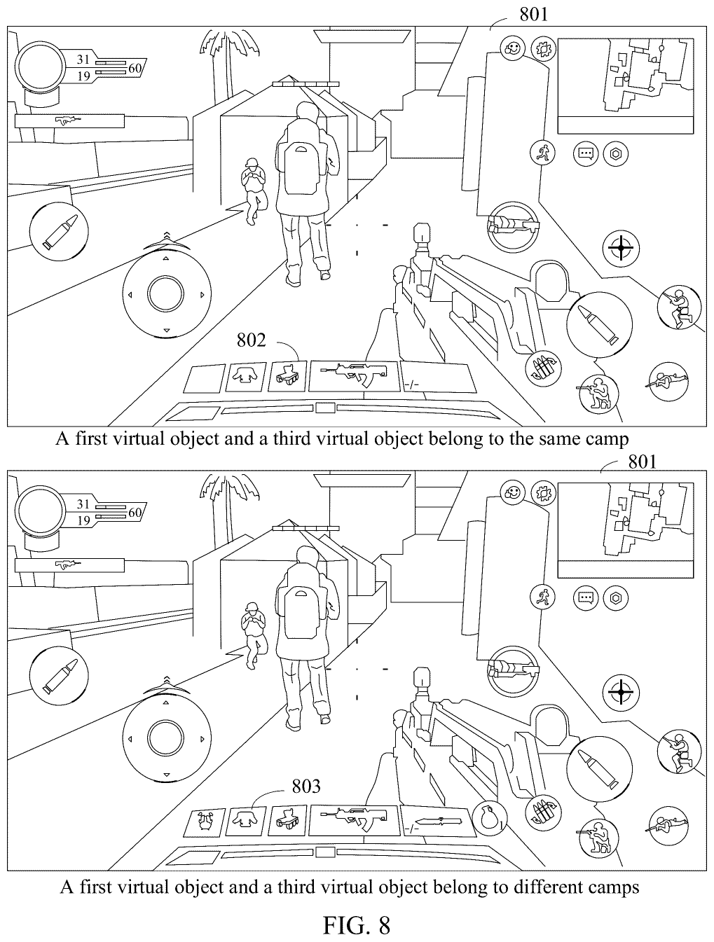

For example, as shown in FIG. 8, when the first virtual object and the third virtual object belong to the same camp, the terminal displays, on a virtual battle interface 801, a first quantity of (two) item controls 802 in the triggerable state. When the first virtual object and the third virtual object belong to different camps, the terminal displays, on the virtual battle interface 801, a second quantity of (three) item controls 803 in the triggerable state.

In another possible implementation, when at least two item controls exist, the terminal determines the camps to which the first virtual object and the third virtual object belong. When the first virtual object and the third virtual object belong to the same camp, the terminal displays, on the virtual battle interface, an item control that is in the triggerable state and that has a first attack value. When the first virtual object and the third virtual object belong to different camps, the terminal displays, on the virtual battle interface, an item control that is in the triggerable state and that has a second attack value. The second attack value is greater than the first attack value.

In another possible implementation, when the first virtual object does not eliminate another virtual object, the terminal displays, on the virtual battle interface, the item control that is in the fourth state. The fourth state is a first cooldown state. When the third virtual object is eliminated by the first virtual object, the terminal displays, on the virtual battle interface, the item control that is in the fifth state. The fifth state is a second cooldown state, and a cooldown recovery speed in the second cooldown state is greater than a cooldown recovery speed in the first cooldown state.

The cooldown recovery speed refers to a speed at which an item control changes from a cooldown state to a non-cooldown state. To be specific, a higher cooldown recovery speed indicates shorter duration (that is, cooldown recovery duration) required by the item control to change from the cooldown state to the non-cooldown state. Otherwise, a lower cooldown recovery speed indicates longer duration required by the item control to change from the cooldown state to the non-cooldown state.

For example, when the first virtual object does not eliminate another virtual object, a cooldown recovery speed of the item control is 5 points/second, and duration of changing from the cooldown state to the non-cooldown state is 20 seconds. When the first virtual object eliminates another virtual object, the cooldown recovery speed of the item control is 10 points/second, and the duration of changing from the cooldown state to the non-cooldown state is 10 seconds.

Further, when the first virtual object eliminates the third virtual object, the terminal may further adjust the cooldown recovery speed of the item control based on the camps to which the first virtual object and the third virtual object belong. In one embodiment, the terminal determines the camps to which the first virtual object and the third virtual object belong. When the first virtual object and the third virtual object belong to the same camp, the terminal displays, on the virtual battle interface, an item control having a first cooldown recovery speed. When the first virtual object and the third virtual object belong to different camps, the terminal displays, on the virtual battle interface, an item control having a second cooldown recovery speed. The second cooldown recovery speed is greater than the first cooldown recovery speed.

For example, when the first virtual object eliminates a third virtual object that is in the same camp as the first virtual object, the cooldown recovery speed of the item control becomes 10 points/second. When the first virtual object eliminates a third virtual object of an enemy camp, the cooldown recovery speed of the item control becomes 20 points/second.

In a possible implementation, to accelerate a battle progress of the virtual battle, the terminal may further display the item control that is in the fifth state on the virtual battle interface based on a sequence of eliminating another virtual object by a virtual object in the virtual battle, that is, a camp disclosing sequence. The camp disclosing sequence represents a sequence in which virtual objects in the virtual battle are switched from the camp hidden state to the camp disclosed state. In one embodiment, when the third virtual object is eliminated by the first virtual object, the terminal may display, on the virtual battle interface based on a camp disclosing sequence corresponding to the first virtual object, the item control that is in the fifth state.

In one embodiment, a higher camp disclosing sequence indicates a larger display quantity, a higher attack value, and a higher cooldown recovery speed of an item control.

In the foregoing embodiment, when the third virtual object is eliminated by the first virtual object, whether the first virtual object and the second virtual object belong to the same camp is determined, to determine a display state of an item control, so that different forms of solutions for displaying the item control are provided, control display forms on the virtual battle interface are enriched, and battle experience of a virtual battle is optimized.

In a possible implementation, after a virtual object eliminates another virtual object, and enters the camp disclosed state, to enable the virtual object to perform, as soon as possible, battle communication with another virtual object belonging to the same camp, and improve battle efficiency of a virtual battle, the terminal may further set a camp chat control when the virtual object enters the camp disclosed state.

In a possible implementation, when the first virtual object does not eliminate another virtual object, the terminal displays, on the virtual battle interface, a camp chat control in an unavailable state. To be specific, in this state, the first virtual object cannot perform battle communication with any other virtual object in the virtual battle. Further, when receiving a trigger operation on an attack instruction, the terminal controls the first virtual object to attack the third virtual object, and displays, on the virtual battle interface when the third virtual object is eliminated by the first virtual object, the camp chat control in an available state. Therefore, the player may trigger the camp chat control to control the first virtual object to perform the battle communication with the another virtual object belonging to the same camp.

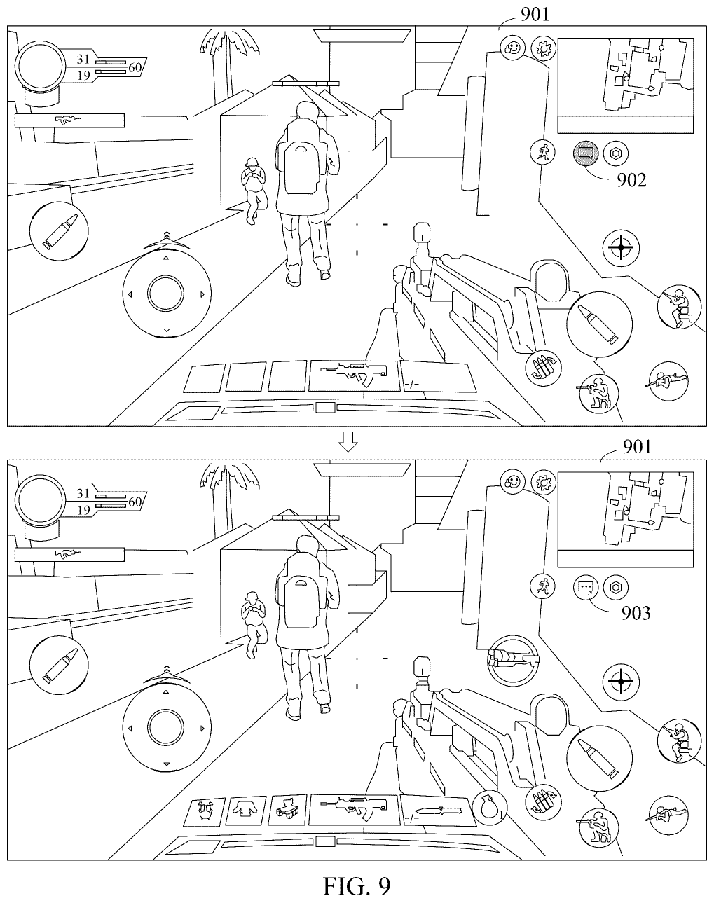

For example, as shown in FIG. 9, when the first virtual object does not eliminate another virtual object, the terminal displays, on a virtual battle interface 901, a camp chat control 902 in an unavailable state. When the third virtual object is eliminated by the first virtual object, the terminal displays, on the virtual battle interface 901, a camp chat control 903 in an available state. Therefore, the player can control the first virtual object to perform the battle communication with another virtual object of the same camp by using the camp chat control 903 in the available state.

In the foregoing embodiment, when the first virtual object is switched from the camp hidden state to the camp disclosed state, the camp chat control is set, so that the first virtual object can be controlled to perform a battle chat with another virtual object belonging to the same camp, to improve battle efficiency of the virtual battle.

In a possible implementation, it is considered that, after entering the virtual battle, each virtual object is in the camp hidden state, and once virtual objects use a negative battle policy and no virtual object is eliminated within long duration, the virtual objects remain in the camp hidden state, resulting in a slow progress of the virtual battle. In this case, to push the battle progress of the virtual battle, the terminal may adjust a camp state of each virtual object in the virtual battle based on battle duration of the virtual battle and a quantity of virtual objects in the camp disclosed state in the virtual battle.

In a possible implementation, when the battle duration of the virtual battle reaches a duration threshold, and the quantity of virtual objects in the camp disclosed state is less than a quantity threshold, the server delivers a camp disclosing instruction to the terminal. Therefore, the terminal receives the camp disclosing instruction, and switches a target quantity of virtual objects in the virtual battle from the camp hidden state to the camp disclosed state based on the camp disclosing instruction.

In one embodiment, the target quantity may be a determined value preset by the server, or may be determined based on the quantity of virtual objects in the camp disclosed state in the current virtual battle and the quantity threshold. For example, the target quantity is equal to the quantity threshold minus the quantity of virtual objects in the camp disclosed state in the current virtual battle.

In one embodiment, when the target quantity is less than a quantity of virtual objects in the camp hidden state in the virtual battle, the terminal may sort the virtual objects in the camp hidden state in ascending order or descending order of life values or energy values of the virtual objects in the camp hidden state, to switch the target quantity of virtual objects from the camp hidden state to the camp disclosed state based on a sorting result.

In one embodiment, when the target quantity is less than the quantity of virtual objects in the camp hidden state in the virtual battle, the terminal may alternatively determine, based on a quantity of virtual objects that are in the camp hidden state of each camp in the virtual battle, a target virtual object from a camp including a large quantity of virtual objects that are in the camp hidden state, and switch the target virtual object from the camp hidden state to the camp disclosed state.

In one embodiment, when the target quantity is less than the quantity of virtual objects in the camp hidden state in the virtual battle, the terminal may alternatively switch the target quantity of virtual objects from the camp hidden state to the camp disclosed state based on another selection criterion. This is not limited in this embodiment of the present disclosure.

In a possible implementation, the server may alternatively set different duration thresholds and different quantity thresholds. For example, when the battle duration of the virtual battle reaches a first duration threshold, and the quantity of virtual objects in the camp disclosed state is less than a first quantity threshold, the server delivers a first camp disclosing instruction to the terminal. The first camp disclosing instruction includes a first target quantity. When the battle duration of the virtual battle reaches a second duration threshold, and the quantity of the virtual objects in the camp disclosed state is less than a second quantity threshold, the server delivers a second camp disclosing instruction to the terminal. The second camp disclosing instruction includes a second target quantity. The first duration threshold is less than the second duration threshold, and the first quantity threshold is less than the second quantity threshold. The first target quantity and the second target quantity may be the same or may be different.

For example, in a 5V5 battle, a first duration threshold corresponding to the virtual battle is 20 minutes, a first quantity threshold is 2, a second duration threshold corresponding to the virtual battle is 40 minutes, and a second quantity threshold is 4. In this case, when the battle duration of the virtual battle reaches 20 minutes, and the quantity of virtual objects that are in the virtual battle and that are in the camp disclosed state is 1, the server may deliver a camp disclosing instruction to the terminal, where a target quantity included in the camp disclosing instruction is 1, so that the terminal switches a virtual object that is among the virtual objects in the camp hidden state and that has a highest life value in the current virtual battle from the camp hidden state to the camp disclosed state. When the battle duration of the virtual battle reaches 40 minutes, and the quantity of virtual objects that are in the virtual battle and that are in the camp disclosed state is 2, the server may deliver a camp disclosing instruction to the terminal, where a target quantity included in the camp disclosing instruction is 2, so that the terminal switches virtual objects that are among the virtual objects in the camp hidden state and that have top two life values in the virtual objects in the current virtual battle from the camp hidden state to the camp disclosed state.

A virtual object that is switched from the camp hidden state to the camp disclosed state in the foregoing mechanism enjoys the same gain as a virtual object that enters the camp disclosed state by eliminating another virtual object. The gain may be a gain in items, a gain in a cooldown recovery speed, or the like.

In the foregoing embodiment, the duration threshold of the virtual battle and the quantity threshold of virtual objects in the camp disclosed state are set. In this way, when the battle duration reaches the duration threshold, and the quantity of virtual objects in the camp disclosed state is less than the quantity threshold, the server sends the camp disclosing instruction to the terminal, to switch the target quantity of virtual objects from the camp hidden state to the camp disclosed state, so as to help accelerate a battle progress and reduce battle duration.

In a possible implementation, to improve efficiency of determining, by a virtual object, another virtual object belonging to the same camp, and avoid mistaken elimination of a virtual object of the camp of the player, a verification item may further be set in the virtual battle, so that the virtual object may perform camp verification on another virtual object that is in the camp hidden state, to complete determining of camp information as soon as possible.

In a possible implementation, the terminal controls the first virtual object to obtain a verification item, where the verification item is configured for verifying a camp to which a virtual object that is in the camp hidden state belongs. In this case, when receiving an item use operation of the player on a fourth virtual object in the virtual battle image, the terminal displays, in the virtual battle image of the first virtual object, a camp to which the fourth virtual object belongs.

In a possible implementation, when the first virtual object is in the camp disclosed state, the player may further notify another virtual object in the same camp of a camp verification result of the fourth virtual object by using the camp chat control.

In the foregoing embodiment, the verification item is added to the virtual battle, so that a virtual object can be provided with an opportunity of performing camp verification on another virtual object that is in the camp hidden state, to help improve strategy of a battle process and diversity of a battle gameplay.

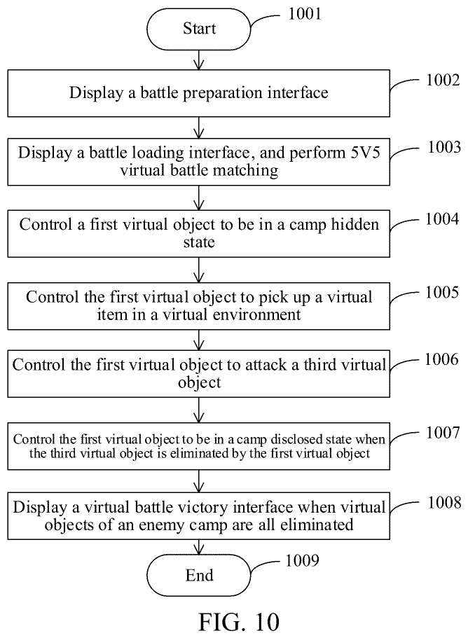

FIG. 10 is a flowchart of a method for displaying a virtual object according to an exemplary embodiment of the present disclosure.

Operation 1001: Start.

Operation 1002: Display a battle preparation interface.

A terminal displays the battle preparation interface, and a player may equip a first virtual object with a corresponding backpack item through the battle preparation interface.

Operation 1003: Display a battle loading interface, and perform 5V5 virtual battle matching.

In response to a trigger operation on a battle start control, the terminal displays the battle loading interface, and performs the 5V5 virtual battle matching. All virtual objects on the battle loading interface that are other than the first virtual object are in a camp hidden state.

Operation 1004: Control the first virtual object to be in the camp hidden state.

After the first virtual object performs a virtual battle, the terminal controls the first virtual object to be in the camp hidden state, in other words, camp information of the first virtual object is in an invisible state to another virtual object in the virtual battle.

Operation 1005: Control the first virtual object to pick up a virtual item in a virtual environment.

In response to a pickup operation on the virtual item in the virtual environment, the terminal controls the first virtual object to pick up the virtual item in the virtual environment.

Operation 1006: Control the first virtual object to attack a third virtual object.

The terminal controls the first virtual object to attack the third virtual object.

Operation 1007: Control, when the third virtual object is eliminated by the first virtual object, the first virtual object to be in a camp disclosed state.

When the third virtual object is eliminated by the first virtual object, the terminal controls the first virtual object to be in the camp disclosed state, in other words, the camp information of the first virtual object is in a visible state to another virtual object in the virtual battle.

Operation 1008: Display a virtual battle victory interface when virtual objects of an enemy camp are all eliminated.

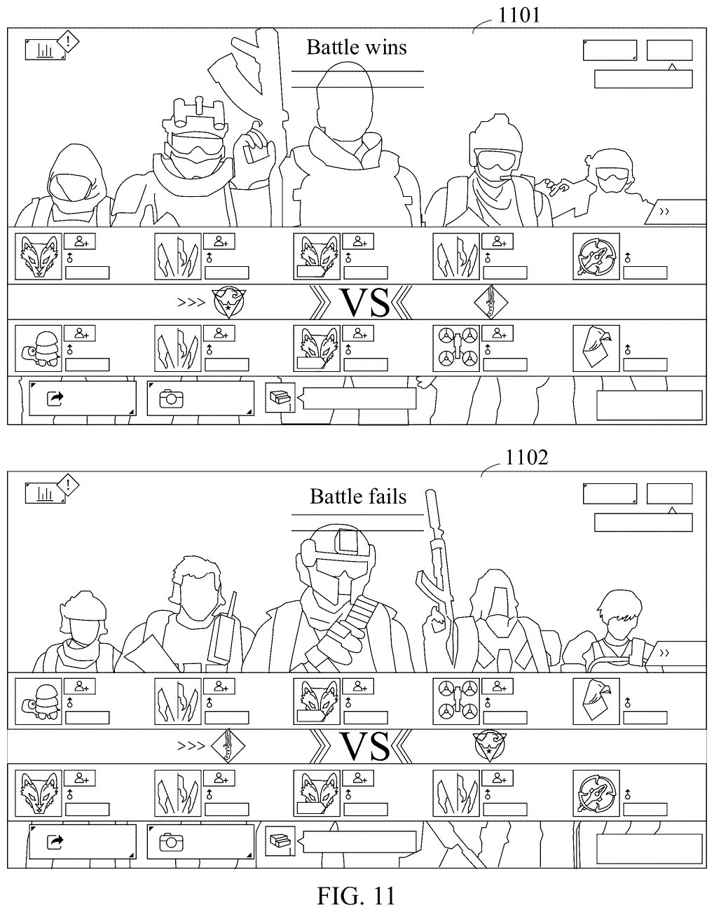

When the virtual objects of the enemy camp are all eliminated, the terminal displays the virtual battle victory interface. For example, as shown in FIG. 11, when all the virtual objects of the enemy camp are eliminated, the terminal displays a virtual battle victory interface 1101. When virtual objects of a camp of the player are all eliminated, the terminal displays a virtual battle failure interface 1102.

Operation 1009: End.

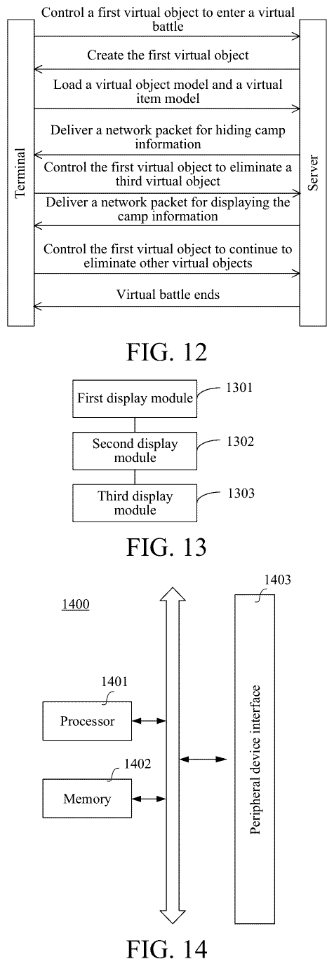

FIG. 12 is a diagram of a time sequence of interaction between a terminal and a server according to an exemplary embodiment of the present disclosure.

When receiving a trigger operation on a battle start control, a terminal controls a first virtual object to enter a virtual battle, and sends a request packet for entering a game to a server. The request packet may include player information, an object attribute, and virtual item information that correspond to the first virtual object. In this case, the server verifies the request packet. When it is confirmed that the request packet is valid, the server sends a network packet for creating the first virtual object to the terminal. In this case, the terminal loads a virtual object model and a virtual item model. Further, the server delivers a network packet for hiding camp information to each terminal in the virtual battle, and each terminal displays, in a virtual battle image based on the network packet, the first virtual object in a camp hidden state. Further, when receiving a trigger operation on an attack instruction, the terminal controls the first virtual object to eliminate a third virtual object. In this case, the server delivers a network packet for displaying the camp information to each terminal in the virtual battle. Each terminal displays, in the virtual battle image, the first virtual object in a camp disclosed state. When continuing to receive the trigger operation on the attack instruction, the terminal controls the first virtual object to eliminate other virtual objects until all virtual objects of one camp are eliminated, and the virtual battle ends.

FIG. 13 is a block diagram of a structure of an apparatus for displaying a virtual object according to an exemplary embodiment of the present disclosure. The apparatus includes:
a first display module 1301, configured to display a virtual battle image, the virtual battle image corresponding to a battle perspective of a first virtual object;
a second display module 1302, configured to display, in the virtual battle image when a second virtual object exists in the battle perspective, the second virtual object in a camp hidden state, the second virtual object not eliminating another virtual object in a virtual battle, and the camp hidden state referring to a state in which a camp to which a virtual object belongs is hidden in the virtual battle; and
a third display module 1303, configured to display, in the virtual battle image when another virtual object is eliminated by the second virtual object and the second virtual object exists in the battle perspective, the second virtual object in a camp disclosed state, the camp disclosed state referring to a state in which a camp to which a virtual object belongs is disclosed in the virtual battle.

In one embodiment, the second display module 1302 is configured to:
display, in the virtual battle image, the second virtual object and an object identifier that is in a first state.

The third display module 1303 is configured to:
display, in the virtual battle image when the second virtual object and the first virtual object belong to the same camp, the second virtual object and an object identifier that is in a second state; or
display, in the virtual battle image when the second virtual object and the first virtual object belong to different camps, the second virtual object and an object identifier that is in a third state.

The first state, the second state, and the third state are different from each other.

In one embodiment, the virtual battle image is located on a virtual battle interface, and the virtual battle interface further includes an item control.

The apparatus further includes:
a fourth display module, configured to display, on the virtual battle interface when the first virtual object does not eliminate another virtual object, the item control that is in a fourth state;
a first control module, configured to control the first virtual object to attack a third virtual object; and
a fifth display module, configured to display, on the virtual battle interface when the third virtual object is eliminated by the first virtual object, the item control that is in a fifth state, the fifth state being different from the fourth state.

In one embodiment, the fifth display module is further configured to:
display, on the virtual battle interface based on camps to which the third virtual object and the first virtual object belong and when the third virtual object is eliminated by the first virtual object, the item control that is in the fifth state.

In one embodiment, the fourth state is an untriggerable state, the fifth state is a triggerable state, and at least two types of item controls exist.

The fifth display module is further configured to:
display, on the virtual battle interface when the third virtual object and the first virtual object belong to the same camp, a first quantity of item controls that are in the triggerable state; or
display, on the virtual battle interface when the third virtual object and the first virtual object belong to different camps, a second quantity of item controls that are in the triggerable state, the second quantity being greater than the first quantity.

In one embodiment, the fourth state is a first cooldown state, the fifth state is a second cooldown state, and a cooldown recovery speed in the second cooldown state is greater than a cooldown recovery speed in the first cooldown state.

The fifth display module is further configured to:
display, on the virtual battle interface when the third virtual object and the first virtual object belong to the same camp, the item control having a first cooldown recovery speed; or
display, on the virtual battle interface when the third virtual object and the first virtual object belong to different camps, the item control having a second cooldown recovery speed, the second cooldown recovery speed being greater than the first cooldown recovery speed.

In one embodiment, the fifth display module is further configured to:
display, on the virtual battle interface based on a camp disclosing sequence of the first virtual object when the third virtual object is eliminated by the first virtual object, the item control that is in the fifth state, the camp disclosing sequence being configured for indicating a sequence in which virtual objects are switched from the camp hidden state to the camp disclosed state.

In one embodiment, the virtual battle image is located on the virtual battle interface, the virtual battle interface further includes a camp chat control, and the camp chat control is configured for triggering a chat in a camp to which a virtual object belongs.

The apparatus further includes:
a sixth display module, configured to display, on the virtual battle interface when the first virtual object does not eliminate another virtual object, the camp chat control that is in an unavailable state;
a second control module, configured to control the first virtual object to attack a third virtual object; and
a seventh display module, configured to display, on the virtual battle interface when the third virtual object is eliminated by the first virtual object, the camp chat control that is in an available state.

In one embodiment, after the display a virtual battle image, the apparatus further includes:
a receiving module, configured to receive a camp disclosing instruction delivered by a server, the camp disclosing instruction being delivered when battle duration of the virtual battle reaches a duration threshold, and a quantity of virtual objects that are in the camp disclosed state is less than a quantity threshold; and
a switching module, configured to switch a target quantity of virtual objects in the virtual battle from the camp hidden state to the camp disclosed state based on the camp disclosing instruction.

In one embodiment, the apparatus further includes:
a third control module, configured to control the first virtual object to obtain a verification item, the verification item being configured for verifying a camp to which the virtual object in the camp hidden state belongs; and
an eighth display module, configured to display, in the virtual battle image in response to an item using operation on a fourth virtual object in the virtual battle image, a camp to which the fourth virtual object belongs.

In one embodiment, before the virtual battle image is displayed, the apparatus further includes:
a ninth display module, configured to display a battle loading interface, a virtual object other than the first virtual object on the battle loading interface being in the camp hidden state.

The apparatus provided in the foregoing embodiment is illustrated only with an example of division of the foregoing function modules. In practical applications, the foregoing functions may be allocated to and completed by different function modules based on requirements. That is, an internal structure of the apparatus is divided into different function modules to complete all or some of the functions described above. In addition, the apparatus provided in the foregoing embodiment and the method embodiment fall within the same conception. For details of an implementation process, refer to the method embodiment. Details are not described herein.

FIG. 14 is a block diagram of a structure of a terminal 1400 according to an exemplary embodiment of the present disclosure. The terminal 1400 may be a portable mobile terminal, for example: a smartphone, a tablet computer, a moving picture experts group audio layer III (MP3) player, and a moving picture experts group audio layer IV (MP4) player. The terminal 1400 may alternatively be referred to as another name such as a user equipment or a portable terminal.

Generally, the terminal 1400 includes: a processor 1401 and a memory 1402.

The processor 1401 may include one or more processing cores, for example, a 4-core processor and an 8-core processor. The processor 1401 may be implemented by using at least one hardware form of a digital signal processing (DSP), a field-programmable gate array (FPGA), and a programmable logic array (PLA). The processor 1401 may alternatively include a main processor and a coprocessor. The main processor is a processor configured to process data in an awake state, and is also referred to as a central processing unit (CPU). The co-processor is a low power consumption processor configured to process data in a standby state. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations correlated with machine learning.

The memory 1402 may include one or more computer-readable storage media. The computer-readable storage media may be tangible and non-transient. The memory 1402 may further include a high-speed random access memory and a non-volatile memory, for example, one or more disk storage devices or flash storage devices. In some embodiments, a non-transient computer-readable storage medium in the memory 1402 is configured to store at least one instruction, and the at least one instruction is executed by the processor 1401 to implement the method for displaying a virtual object provided in the embodiments of the present disclosure.

In some embodiments, the terminal 1400 may further include: a peripheral device interface 1403 and at least one peripheral device.

The peripheral interface 1403 may be configured to connect at least one peripheral device related to input/output (I/O) to the processor 1401 and the memory 1402. In some embodiments, the processor 1401, the memory 1402, and the peripheral interface 1403 are integrated on the same chip or circuit board. In some other embodiments, any one or two of the processor 1401, the memory 1402, and the peripheral interface 1403 may be implemented on an independent chip or circuit board. This is not limited in this embodiment.

A person skilled in the art may understand that the structure shown in FIG. 14 constitutes no limitation on the terminal 1400, and the terminal may include more or fewer components than those shown in the figure, or some components may be combined, or different component deployments may be used.

An embodiment of the present disclosure further provides a computer-readable storage medium, the computer-readable storage medium having at least one program stored therein, and the at least one program being loaded and executed by a processor to implement the method for displaying a virtual object in the foregoing embodiments.

In an aspect of the present disclosure, a computer program product is provided, the computer program product including computer instructions, the computer instructions being stored in a computer-readable storage medium. A processor of a terminal reads the computer instructions from the computer-readable storage medium, and executes the computer instructions, to cause the terminal to implement the method for displaying a virtual object in the various implementations of the foregoing aspect.

A person skilled in the art may be aware that in the foregoing one or more examples, functions described in embodiments of the present disclosure may be implemented by using hardware, software, firmware, or any combination thereof. When being implemented by using software, the functions can be stored in a computer-readable storage medium or can be used as one or more instructions or codes in the computer-readable storage medium for transmission. The computer-readable storage medium includes a computer storage medium and a communications medium, where the communications medium includes any medium that enables a computer program to be transmitted from one place to another. The storage medium may be any available medium accessible to a general-purpose or special-purpose computer.

The foregoing descriptions are merely exemplary embodiments of the present disclosure, and are not intended to limit the present disclosure. Any modification, equivalent replacement, or improvement made within the spirit and principle of the present disclosure shall fall within the protection scope of the present disclosure.

What is claimed is:

1. A method for displaying a virtual object, the method being performed by a terminal, and comprising:
displaying a virtual battle image, wherein the virtual battle image corresponds to a battle perspective of a first virtual object;
displaying, in the virtual battle image and based on a second virtual object existing in the battle perspective, the second virtual object in a camp hidden state, wherein the second virtual object does not eliminate another virtual object in a virtual battle, and wherein the camp hidden state is a state in which a camp to which a virtual object belongs is hidden in the virtual battle; and
displaying, in the virtual battle image, based on another virtual object being eliminated by the second virtual object, and based on the second virtual object existing in the battle perspective, the second virtual object in a camp disclosed state, wherein the camp disclosed state is a state in which a camp to which a virtual object belongs is disclosed in the virtual battle.

2. The method according to claim 1, wherein the displaying, in the virtual battle image and based on the second virtual object existing in the battle perspective, the second virtual object in the camp hidden state comprises:
displaying, in the virtual battle image, the second virtual object and an object identifier that is in a first state; and
wherein the displaying, in the virtual battle image, based on the other virtual object being eliminated by the second virtual object, and based on the second virtual object existing in the battle perspective, the second virtual object in the camp disclosed state comprises:
displaying, in the virtual battle image and based on the second virtual object and the first virtual object belonging to a same camp, the second virtual object and an object identifier that is in a second state; or
displaying, in the virtual battle image and based on the second virtual object and the first virtual object belonging to different camps, the second virtual object and an object identifier that is in a third state;
wherein the first state, the second state, and the third state are different from each other.

3. The method according to claim 1, wherein the virtual battle image is located on a virtual battle interface, and the virtual battle interface further comprises an item control; and
wherein the method further comprises:
displaying, on the virtual battle interface and based on the first virtual object not eliminating another virtual object, the item control that is in a fourth state; and
controlling the first virtual object to attack a third virtual object; or
displaying, on the virtual battle interface and based on the third virtual object being eliminated by the first virtual object, the item control that is in a fifth state, wherein the fifth state is different from the fourth state.

4. The method according to claim 3, wherein the displaying, on the virtual battle interface and based on the third virtual object being eliminated by the first virtual object, the item control that is in the fifth state comprises:
displaying, on the virtual battle interface, based on camps to which the third virtual object and the first virtual object belong, and based on the third virtual object being eliminated by the first virtual object, the item control that is in the fifth state.

5. The method according to claim 4, wherein the fourth state is an untriggerable state, the fifth state is a triggerable state, and at least two types of item controls exist; and
wherein the displaying, on the virtual battle interface, based on camps to which the third virtual object and the first virtual object belong, and based on the third virtual object being eliminated by the first virtual object, the item control that is in the fifth state comprises:
displaying, on the virtual battle interface and based on the third virtual object and the first virtual object belonging to a same camp, a first quantity of item controls that are in the triggerable state; or
displaying, on the virtual battle interface and based on the third virtual object and the first virtual object belonging to different camps, a second quantity of item controls that are in the triggerable state, wherein the second quantity is greater than the first quantity.

6. The method according to claim 4, wherein the fourth state is a first cooldown state, the fifth state is a second cooldown state, and a cooldown recovery speed in the second cooldown state is greater than a cooldown recovery speed in the first cooldown state; and
wherein the displaying, on the virtual battle interface, based on camps to which the third virtual object and the first virtual object belong, and based on the third virtual object being eliminated by the first virtual object, the item control that is in the fifth state comprises:
displaying, on the virtual battle interface and based on the third virtual object and the first virtual object belonging to a same camp, an item control having a first cooldown recovery speed; or
displaying, on the virtual battle interface and based on the third virtual object and the first virtual object belonging to different camps, an item control having a second cooldown recovery speed, wherein the second cooldown recovery speed is greater than the first cooldown recovery speed.

7. The method according to claim 3, wherein the displaying, on the virtual battle interface and based on the third virtual object being eliminated by the first virtual object, the item control that is in the fifth state comprises:
displaying, on the virtual battle interface, based on a camp disclosing sequence of the first virtual object, and based on the third virtual object being eliminated by the first virtual object, the item control that is in the fifth state, wherein the camp disclosing sequence is configured to indicate a sequence in which virtual objects are switched from the camp hidden state to the camp disclosed state.

8. The method according to claim 1, wherein the virtual battle image is located on a virtual battle interface, the virtual battle interface further comprises a camp chat control, and the camp chat control is configured to trigger a chat in a camp to which a virtual object belongs; and
wherein the method further comprises:
displaying, on the virtual battle interface and based on the first virtual object not eliminating another virtual object, the camp chat control that is in an unavailable state; and
controlling the first virtual object to attack a third virtual object; or
displaying, on the virtual battle interface and based on the third virtual object being eliminated by the first virtual object, the camp chat control that is in an available state.

9. The method according to claim 1, wherein after the displaying the virtual battle image, the method further comprises:
receiving a camp disclosing instruction from a server, wherein the camp disclosing instruction is sent based on a battle duration of the virtual battle reaching a duration threshold, and based on a quantity of virtual objects that are in the camp disclosed state being less than a quantity threshold; and
switching, based on the camp disclosing instruction, a target quantity of virtual objects in the virtual battle from the camp hidden state to the camp disclosed state.

10. The method according to claim 1, further comprising:
controlling the first virtual object to obtain a verification item, wherein the verification item is configured to verify a camp to which a virtual object in the camp hidden state belongs; and
displaying, in the virtual battle image and in response to an item using operation on a fourth virtual object in the virtual battle image, a camp to which the fourth virtual object belongs.

11. The method according to claim 1, wherein before the displaying the virtual battle image, the method further comprises:
displaying a battle loading interface, wherein a virtual object other than the first virtual object on the battle loading interface is in the camp hidden state.

12. A terminal, comprising:
one or more processors; and
memory storing instructions that, when executed by the one or more processors, cause the terminal to facilitate:
displaying a virtual battle image, wherein the virtual battle image corresponds to a battle perspective of a first virtual object;
displaying, in the virtual battle image and based on a second virtual object existing in the battle perspective, the second virtual object in a camp hidden state, wherein the second virtual object does not eliminate another virtual object in a virtual battle, and wherein the camp hidden state is a state in which a camp to which a virtual object belongs is hidden in the virtual battle; and
displaying, in the virtual battle image, based on another virtual object being eliminated by the second virtual object, and based on the second virtual object existing in the battle perspective, the second virtual object in a camp disclosed state, wherein the camp disclosed state is a state in which a camp to which a virtual object belongs is disclosed in the virtual battle.

13. The terminal according to claim 12, wherein the instructions, when executed by the one or more processors, cause the terminal to facilitate:
displaying, in the virtual battle image, the second virtual object and an object identifier that is in a first state; and
wherein the displaying, in the virtual battle image, based on the other virtual object being eliminated by the second virtual object, and based on the second virtual object existing in the battle perspective, the second virtual object in the camp disclosed state comprises the instructions causing the terminal to facilitate:
displaying, in the virtual battle image and based on the second virtual object and the first virtual object belonging to a same camp, the second virtual object and an object identifier that is in a second state; or
displaying, in the virtual battle image and based on the second virtual object and the first virtual object belonging to different camps, the second virtual object and an object identifier that is in a third state;
wherein the first state, the second state, and the third state are different from each other.

14. The terminal according to claim 12, wherein the virtual battle image is located on a virtual battle interface, and the virtual battle interface further comprises an item control; and
wherein the instructions, when executed by the one or more processors, cause the terminal to facilitate:
displaying, on the virtual battle interface and based on the first virtual object not eliminating another virtual object, the item control that is in a fourth state; and
controlling the first virtual object to attack a third virtual object; or
displaying, on the virtual battle interface and based on the third virtual object being eliminated by the first virtual object, the item control that is in a fifth state, wherein the fifth state is different from the fourth state.

15. The terminal according to claim 14, wherein the instructions, when executed by the one or more processors, cause the terminal to facilitate:
displaying, on the virtual battle interface, based on camps to which the third virtual object and the first virtual object belong, and based on the third virtual object being eliminated by the first virtual object, the item control that is in the fifth state.

16. The terminal according to claim 15, wherein the fourth state is an untriggerable state, the fifth state is a triggerable state, and at least two types of item controls exist; and
wherein the displaying, on the virtual battle interface, based on camps to which the third virtual object and the first virtual object belong, and based on the third virtual object being eliminated by the first virtual object, the item control that is in the fifth state comprises the instructions causing the terminal to facilitate:
displaying, on the virtual battle interface and based on the third virtual object and the first virtual object belonging to a same camp, a first quantity of item controls that are in the triggerable state; or
displaying, on the virtual battle interface and based on the third virtual object and the first virtual object belonging to different camps, a second quantity of item controls that are in the triggerable state, wherein the second quantity is greater than the first quantity.

17. The terminal according to claim 15, wherein the fourth state is a first cooldown state, the fifth state is a second cooldown state, and a cooldown recovery speed in the second cooldown state is greater than a cooldown recovery speed in the first cooldown state; and
wherein the displaying, on the virtual battle interface, based on camps to which the third virtual object and the first virtual object belong, and based on the third virtual object being eliminated by the first virtual object, the item control that is in the fifth state comprises the instructions causing the terminal to facilitate:
displaying, on the virtual battle interface and based on the third virtual object and the first virtual object belonging to a same camp, an item control having a first cooldown recovery speed; or
displaying, on the virtual battle interface and based on the third virtual object and the first virtual object belonging to different camps, an item control having a second cooldown recovery speed, wherein the second cooldown recovery speed is greater than the first cooldown recovery speed.

18. The terminal according to claim 14, wherein the instructions, when executed by the one or more processors, cause the terminal to facilitate:
displaying, on the virtual battle interface, based on a camp disclosing sequence of the first virtual object, and based on the third virtual object being eliminated by the first virtual object, the item control that is in the fifth state, wherein the camp disclosing sequence is configured to indicate a sequence in which virtual objects are switched from the camp hidden state to the camp disclosed state.

19. The terminal according to claim 12, wherein the virtual battle image is located on a virtual battle interface, the virtual battle interface further comprises a camp chat control, and the camp chat control is configured to trigger a chat in a camp to which a virtual object belongs; and
wherein the instructions, when executed by the one or more processors, cause the terminal to facilitate:
displaying, on the virtual battle interface and based on the first virtual object not eliminating another virtual object, the camp chat control that is in an unavailable state; and
controlling the first virtual object to attack a third virtual object; or
displaying, on the virtual battle interface and based on the third virtual object being eliminated by the first virtual object, the camp chat control that is in an available state.

20. A non-transitory computer-readable medium, having computer-executable instructions stored thereon, the computer-executable instructions, when executed by one or more processors of a terminal, cause the terminal to facilitate:
displaying a virtual battle image, wherein the virtual battle image corresponds to a battle perspective of a first virtual object;
displaying, in the virtual battle image and based on a second virtual object existing in the battle perspective, the second virtual object in a camp hidden state, wherein the second virtual object does not eliminate another virtual object in a virtual battle, and wherein the camp hidden state is a state in which a camp to which a virtual object belongs is hidden in the virtual battle; and
displaying, in the virtual battle image, based on another virtual object being eliminated by the second virtual object, and based on the second virtual object existing in the battle perspective, the second virtual object in a camp disclosed state, wherein the camp disclosed state is a state in which a camp to which a virtual object belongs is disclosed in the virtual battle.
